(19) United States
(12) Patent Application Publication
(10) Pub. No.: US 2024/0378542 A1
(43) Pub. Date: Nov. 14, 2024

(54) PERFORMANCE MANAGEMENT BUSINESS METHOD

(71) Applicants: Edgar Quinones, San Juan, PR (US); Eduardo Arroyo, San Juan, PR (US)

(72) Inventors: Edgar Quinones, San Juan, PR (US); Eduardo Arroyo, San Juan, PR (US)

(21) Appl. No.: 18/773,505

(22) Filed: Jul. 15, 2024

Related U.S. Application Data
(63) Continuation-in-part of application No. 17/711,217, filed on Apr. 1, 2022.
(60) Provisional application No. 63/171,601, filed on Apr. 7, 2021.

(51) Int. Cl. G06Q 10/0639

(52) U.S. Cl. CPC G06Q 10/06395

(57) ABSTRACT

A system for applying performance management includes a supervisory computer for allowing a manager to document an organization mission, vision, strategic objectives, expected behavior, and systemic performance indicators. The system includes at least one management computer in communication with the supervisory computer with a management application for allowing the manager to convey the organization mission, the organization vision, the organization strategic objectives, the organization expected behaviors, and the organization systemic performance indicators to at least one employee. The system includes at least one employee computer in communication with the supervisory computer with an employee application for guiding the employee to assemble systemic performance indicators data, provide a review of the systemic performance indicators, analyze the Systemic Performance Indicators, document the review of the Systemic Performance Indicators and identify and document suggested corrective actions for Systemic Performance Indicators that are not in compliance with agreed to Systemic Performance Indicators.

### CROSS-REFERENCE TO RELATED APPLICATIONS

This application claims the benefit of U.S. patent application Ser. No. 17/711,217, filed on Apr. 1, 2022, which claims priority to U.S. Provisional Patent Application No. 63/171,601, filed on Apr. 7, 2021, both of which are incorporated by reference herein in their entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### Field of the Invention

The invention relates to the field of performance management and more specifically to a business method for performance management.

### Description of Related Art

Currently the state of the art includes a number of systems both automated and manual to assess employee performance. Companies typically involve numerous stakeholders having interests that may be different, but should be aligned for achieving a common objective. Stakeholders can include but are not limited to; Stockholders, Family Council, Board of Directors, CEO, President, Senior Staff, Managers, Supervisors, Team Leaders, Employees, Regulatory Agencies, Suppliers and the end users or customers that demand that the products or services requested be executed and performed fulfilling their needs and expectations. Currently there is enormous subjectivity in the traditional External Judgment Based Performance Evaluation Process.

Due to the often complex and distributed nature of modern organizations, there is a need for a consistent assessments system that includes provisions for stakeholders, employees and management.

One issue with any online system that interfaces with government or large business systems is security. There is a need to ensure that the individual or smart device interacting with the system is a sanctioned user or sanctioned device. The biggest issues in cyber security are:
Configuration Mistakes.
Poor Cyber Hygiene.
Cloud Vulnerabilities.
Mobile Device Vulnerabilities.
Internet of Things.
Ransomware.
Poor Data Management.
Inadequate Post-Attack Procedures.

With current talent management systems, and balancing responsibilities and results, many focus heavily on either specific tasks or competencies, or they rely on rigid, prescriptive methods that can feel forced to employees. These systems often emphasize compliance with predefined roles and responsibilities without integrating continuous process improvement to achieve better results. With current talent management systems, many focus heavily on either specific tasks or competencies, or they rely on rigid, prescriptive methods that can feel forced to employees. These systems often emphasize compliance with predefined roles and responsibilities without integrating continuous process improvement to achieve better results. In contrast, the proposed method emphasizes a dynamic approach where responsibilities are clearly defined and continuously optimized, fostering a culture of improvement and adaptability.

For participative performance evaluation, methods for using current systems which implement traditional performance management often involve top-down assessments that can be demotivating and fail to engage employees effectively. These systems typically lack mechanisms for self-assessment, employee participation, and growth mindset development opportunities in the evaluation process. In implementing process improvement-based results, talent management frameworks are static, focusing on fulfilling tasks prescribed on rigid job descriptions or meeting set competencies without an inherent focus on process improvement. This can lead to stagnation and a lack of innovation in performance management.

In implementing process improvement-based results, many talent management frameworks are static, focusing on fulfilling tasks or meeting set competencies without an inherent focus on process improvement. This can lead to stagnation and a lack of innovation in performance management.

There is an innovative nature of the Custom GPT AI assistant and its role in enhancing organizational performance through advanced AI technology.

The instant invention addresses the problem of cloud vulnerabilities and mobile device vulnerabilities. By creating a system that allows access to the systems while ensuring that the devices interacting with the system are sanctioned and allowed to use the system. The instant invention has two methods it can employ to solve the authorized connection problem which is at the heart of any Cloud Vulnerabilities and Mobile Device Vulnerabilities issues. It can use a Global Positioning System (GPS) location filter or an Internet Protocol (IP) address (IP address) filter that allows only those devices that either are from the correct or allowed GPS locations or have the correct IP address. The instant invention can use these filter either individually or in combination to limit access to the system. The instant invention because of these security measures results in a system that can only be implemented with a dedicated network of computerized devices. That network comprising of a cloud server and remote sanctioned smart devices that have either a validated IP address or are located in a sanctioned location that is verified by the GPS location.

In particular there is a need for a solution to at least one of the aforementioned problems. For instance, there is a need for improved external performance assessments.

### BRIEF SUMMARY OF THE INVENTION

The instant invention in one form is directed to a business method which is a Holistic Systemic Result Based Highly Effective and Painless Performance Management System that emphasizes on results and accountability which provides a structured and disciplined method for employees and management. The instant invention provides the user of the system a unique, highly effective, extremely objective, and painless Self-Assessment Performance Management System that is created to promote consistent, aligned, and spectacular individual and organizational systemic results and promote an engaging work environment for all. This is achieved by provoking frequent periodic, guided specific and honest communication, developing continued clear bidirectional expectations while promoting individual introspection, a continuous improvement mindset and structured and disciplined accountability for all results obtained by using the system and methods of the instant invention.

The problem solved by the instant invention is the elimination of subjectivity that is present in the traditional external judgment-based performance evaluation process for all levels within an organization. The instant invention is an objective process which is designed to provoke employee's self-awareness, introspection and accountability of their results using actual results, math, visual aids, tools, technology, and software. The process provides substantial individual execution autonomy while retaining systemic coherence. This is an extremely important characteristic in attracting and retaining top talent, particularly so in millennials and more recent generations and in remote/virtual/hybrid working environments. The instant invention enhances clear accountability in global, virtual, and other physically separate structures and at the same time augments focus and urgency on organizational strategic priorities, a very large and up to now unsolved challenge.

In a first implementation of the invention, is a manual or computerized system which incorporates management input, employee input and eliminates the subjective nature of performance assessments thereby making the performance assessment process more understandable and easier to implement than existing systems.

These and other objects, features, and advantages of the present invention will become more readily apparent from the attached drawings and the detailed description of the preferred embodiments, which follow.

In the method which balances responsibilities and results, there are similarities to the information in the book “The Good, The Bad, and the Troubled: A leadership guide for effective and painless performance management” copyrighted 2010 when the first printing occurred by its author Eduardo M. Arroyo, who is also one of this patent's applicant. This method uniquely integrates a balanced approach by emphasizing not only the allocation of responsibilities but also the achievement of results through continuous process improvement. This dual focus ensures that responsibilities are clearly defined and agreed upon, measurable and aligned with desired outcomes, fostering a culture of harmony, engagement, accountability, and improvement. Unlike traditional talent management systems that focus solely on specific tasks or rigid, prescriptive methods, this approach continuously seeks ways to enhance processes and outcomes, thus driving overall performance improvements.

In regard to participative performance evaluation, the system includes participative elements, allowing employees to objectively assess their own performance based on pre-agreed expectations. This participative approach maximizes engagement by making employees active participants in their development, rather than passive recipients of top-down evaluations. It promotes a higher understanding of clear expectations and creates a more dynamic and motivating work environment, which is especially beneficial for managing off-site or hybrid workers, solving major drawbacks currently seen as a barrier, and enabling that this irreversible trend is effectively managed by all. This method ensures that employees, including hybrid and satellite workers, are fully engaged and invested in their personal and professional growth.

In implementing process improvement-based results, the method is designed around continuous process improvement, similar to the methodology outlined in ‘The Good, The Bad, and the Troubled’. This approach not only sets clear responsibilities but also consistently seeks ways to enhance processes and outcomes. This unique and painless approach ensures that performance management is not merely about meeting current standards but is focused on continuously raising them to achieve better results. By fostering a culture of ongoing improvement and a growth mindset, this method significantly enhances overall organizational performance and employee satisfaction. It is very important to highlight that a growth mindset is the element with the highest correlation with both individual and organizational success. Establishing a growth mindset is cherished by major corporations, including Microsoft, who particularly focused on it as a driver for their reactivated success in a VUCA world from 2014 onward.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is the overall flow chart of the instant invention.

FIG. 2 is a front-end flow chart of the instant invention.

FIG. 3 is an organizational process flow chart of the instant invention.

FIG. 4 is a backend end flow chart of the instant invention.

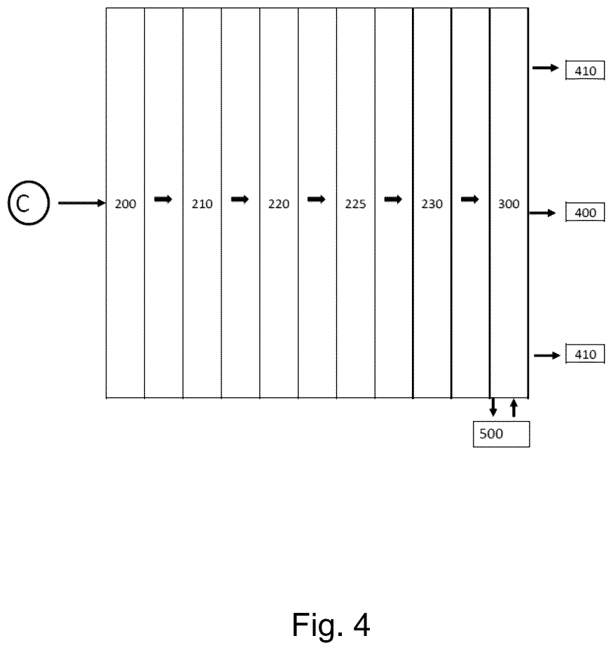

FIG. 5 shows the main responsibilities screen.

FIG. 6 shows the Performance screen.

FIG. 7 shows the Performance summary screen.

FIG. 8 shows the performance trends screen.

FIG. 9 shows the responsibility detail screen.

FIG. 10 shows the indicator results screen

FIG. 11 shows the result chart screen.

FIG. 12 shows the department results.

FIG. 13 is diagram showing a system for using a Performance Management Business Method.

FIG. 14 is diagram showing an alternate system for using a Performance Management Business Method.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms employee and team member are used interchangeably to mean an individual who works for an organization that is using the instant invention.

The term company and organization as used in the specification is meant to mean either a company or other entity such as a government, or non-government, profit or nonprofit organization.

Prior to a discussion of the preferred embodiment of the invention, it should be understood that while the features and advantages of the invention are illustrated in terms of Performance Indicators and Expectations that the system can be used for any process where individual and organizational performance is evaluated. Performance Indicators are primarily related to Primary Responsibilities but can also be used for, but not limited to, task performance, quality of output, on time results, new client recruitment, response times, service times or any other job-related performance factor.

The current processes used by most organizations to track and rate employee performance include an evaluation process which are highly centered on subjective external performance assessment.

Subjective external performance assessments have fallen short of achieving the goal of substantially improving performance of employees because they are:
highly subjective
focused on the judgment of the one who evaluates, which for many can result in destroying their passion (“engagement”)
is communicated poorly
the process input usually mentally or verbally justifies the reviewers actions
the process does not force effective, objective, and periodic dialogue
the process does not support either individual or process development more often than not resulting in demotivation of both the employee and the supervisor instead of engaging
the process does not promote “accountability”—which is to assume responsibility and be held accountable for the results obtained (good or bad)
the process does not promote systemic integration

The goal of Leadership in any system is to continuously improve the System, the cost effectiveness of all processes, and create and maintain an inspiring and highly engaging work environment for all, promoting the achievement of the organizations Mission, Vision, and desired Organizational Culture/Expected Behaviors.

The instant invention is a Holistic, Systemic, Results Based, Highly Effective and Painless Business Performance Management Method. Is also a unique, highly effective, extremely objective, and painless Self-Assessment Performance Management System that promotes consistent, aligned, and spectacular individual and organizational systemic results and promote an engaging work environment for all. This is achieved by provoking frequent periodic, guided specific and honest communication, developing continued clear bidirectional expectations while promoting individual introspection, a continuous improvement mindset and structured and disciplined accountability for all obtained results.

The current state of the art are evaluation processes centered on subjective external performance assessment.

The subjective external performance assessments have fallen short of achieving the goal of substantially improving performance among other reasons because:
a. They are highly subjective.
b. They are focused on the judgment of the one who evaluates, which for many can result in destroying their passion (“engagement”).
c. They do not create a shared set of criteria to guide the effectiveness of the work process, and a route to improve results in a constructive and non-destructive fashion.
d. They do not promote effective dialog between parties.
e. The employee who receives the input usually mentally or verbally justifies their actions.
f. The process does not support either individual or process development more often than not resulting in demotivation of both the employee and the supervisor instead of engaging
g. The systems do not force effective, objective, and periodic dialogue.
h. The systems do not promote “accountability”-which is to assume responsibility and be held accountable for the results obtained (good or bad).
i. The systems do not promote systemic integration.

Whereas the leadership's role in performance management is to continuously improve the cost effectiveness of all processes in the system and to promote an inspiring work environment for all.

Several elements make this process unique. Several of them are a staple in themselves, weaving a systemic and synergistic process that integrates both the strategic and operational portions of the leadership and management processes in a practical easy to teach and delegate and proven system makes this work unique. This specific weaving methodology, referred to by Arroyo as “STRATEXEC,” is detailed in his second book on strategic planning titled “Strategic Execution: An Integrated Planning and Execution Workbook to Maximize Results,” copyrighted in 2020. This work builds on his foundational 1994 publication “The Making of a Leader” and is further cemented by his pioneering 2023 book, “ChatGPT Powered Strategic Planning: Maximizing Results Combining STRATEXEC with AI.”

While there are other performance management systems, we know of none of them that come even close to addressing all the following critical factors in a fully holistic and integrated seamless methodology:
1. the vertical strategic organizational coherence
2. a process that catapults objective two-way communications based on data that currently is an aspiration and a challenge for most organizations
3. a practical, adaptable, and thorough process for establishing and documenting Primary Responsibilities and objective Performance Indicators for every possible Job Position in any type of organization
   a. The method and system cumulative available data base counts with Documented Primary Responsibilities for almost 1000 Job Positions and growing daily based on users' input
   b. Includes over 2,000 Performance Indicators with the flexibility of creating your own, and growing daily based on users' input
   c. This combination allows to create or design a Job Position with related Performance Indicators and Minimum Expected Results profile in under 30 minutes. Or in less than five minutes when utilizing the private data-trained Custom AI ChatBot integrated into the platform.
   d. The method fully addresses a very broad range of Critical Responsibilities, including Risk Management, Operational, Administrative, Strategic Project Management, Supervisory, Financial, Asset Protection, Regulatory, Developmental/successional, and Behavioral Primary Responsibilities, among others.
4. a process that at the same time provides and maintains a formal periodic and simple process that balances both expectations and autonomy together with objective execution indicators and clear minimum expectations required for all Primary Responsibilities
5. a process that promotes continuous improvement, for both work methodology and person, in every aspect of the relationship
6. Allows for a unified process to manage physically present, remote, and hybrid workers, addressing and resolving key challenges that are present in physical scenarios but amplified in remote and hybrid environments, such as objectively evaluating execution, promoting growth, and elevating engagement.
7. tracks systemic, aggregate and individual performance results, development, and growth.
8. department aggregate results promote team integration and improvements
9. organizational wide aggregate results provoke interdepartmental communication and horizontal integration as one team/system
10. converts organizational strategies into traceable and executable projects
11. tracks if projected innovative results become a reality or short- and long-term fine tuning and or adjustments of the Strategic Process are required
12. provides individual and departmental measurements of objective behaviors/conducts vs targeted Vision Based Desired Behaviors/Culture
13. maintains and safeguards historic agreements, comments, audit trails, performance improvement plans and execution results
14. provides clear graphic trend comparison vs expectations with algorithmic based comments to promote introspection without external comments or judgements
15. tailored for fast deployment and implementation no matter the organizations size
16. aggregate results generated provide facts for establishing both targeted individual performance coaching and development, all the way up to strategic opportunity areas for the whole organization Strategic Projects and Continuous Improvement Initiatives
17. an organizational-wide identical talent execution framework allows for easier leadership transferability, both lateral and vertical, as well as faster onboarding provided by a clear framework of position responsibilities, expectations, and objective performance judging metrics.
18. Provides clear and logical focus for directing the limited organization's resources, an irrefutable and non-substitutable prerequisite to both operational and strategic effectiveness

The instant invention encompassed by the results and accountability system highly effective and painless performance management business method is a unique and extremely objective self-assessment performance management system that is created to promote consistent, aligned organizational results. This is achieved by provoking frequent periodic, guided specific and honest communications while promoting individual introspection and accountability for all results obtained.

The current evaluation processes are highly centered on subjective external performance assessment. The problem is so widespread that virtually no organization is satisfied with the effectiveness and practicality of the current performance management models or system. The current state of most organizations highlight the problem. Most organizations fall into one of three categories; they have recently changed their performance management system; they are in the process of changing it or they are actively searching for a more effective option. This problem and state of the processes has been the same for at least last 30 years.

Subjective external performance assessments have fallen short of achieving the goal of substantially improving performance among many other shortcomings.

The instant invention comprises the following components:
A module, process and or methodology for management to document the organization's mission; a requirement a scientifically based organizational design.
A module, process and or methodology for management to document the organization's vision; a shared aspiration to where our objectives must logically lead us to.
A module, process and or methodology for management to document the organization's strategic objectives;
A module, process and or methodology for management to document the organization's expected behaviors, specifically selected to support the achievement of the Strategic Objectives and the realization of the Vision, operationalizing the theory that culture follows strategy.
A module, process and or methodology for management to document the organization's systemic performance indicators;
A module, process and or methodology for the employee input, review and analysis module;

The key question is how does an organization implements the instant invention within an organization.

First, The organizations top management, in coordination with Board of Directors and Stockholders/Family Council, must determine and document the organization's Mission, Vision, Strategic Objectives, Expected Behaviors and Systemic Performance Indicators.
The Mission Statement must be documented as expected results using an extremely specific method; verb, who or what receives the verb and expected results. No more than 15 words is highly preferred. Key concepts or specific words must be clearly explained to avoid different interpretations of the Mission Statement. Emphasis must be placed on the value that is added by the organization and not on the how it is added. High level Performance Indicators for the Mission Statement must be determined and documented.
The Vision Statement must be identified and documented. No more than 12 extremely specific high-level Vision Results/Strategic Objectives for each entity should be determined and documented. The high-level results for the Vision can be bulleted or paragraphs. The way they are documented should inspire people to want to achieve them. For each extremely specific high-level Vision Results/Strategic Objectives, Performance Indicators must be determined and documented.

For each extremely specific high-level Vision Results/Strategic Objectives a highly detailed specific action plan must be established and documented (Assigned Projects Compliance Register highly recommended)

Organizational Values and Principles must be identified and documented (no more than 12). Each value and/or principle should be operationalized by stating expected observable behaviors for each, so everyone understands what specific behaviors are expected from people that follow those values and principles. Consider having at least two sets of behaviors that reflect the required culture: managers and non-managers. The objective of two sets of behaviors is to have samples that any employee can relate to no matter where they are assigned to work. Emphasis must be placed on assuring that they are correctly documented as behaviors and not values. Performance Indicators must be identified and documented for Expected Behaviors compliance. This solves the eternal conflict of confused expectations at performance evaluation time.

For each Job Position within the organization the following must be addressed.
The high-level contribution to the Mission must be documented as expected results using an extremely specific method; verb, who or what receives the verb and expected results. This process cannot be taken as a simple event, since it starts by landing exactly why, in terms of mission-value based systemic-organization focused perspective, this position is needed.
Primary Responsibilities must be documented as expected results using an extremely specific method; verb, who or what receives the verb and expected results.
To promote effective recruiting and Skill Gap Analysis for each Primary Responsibility documented the essential skills and technical capabilities necessary to fulfill them effectively must be identified and documented.
For the essential skills and technical capabilities necessary to fulfill the Primary Responsibilities an objective manner to evaluate each one must be identified and documented.
For each objective manner to evaluate the skills and technical capabilities the minimum grade required to validate the level of mastery must be identified and documented. This step is of the utmost importance and should be used to recruit effectively and train when opportunity area identified in Skill Gap Analysis.
Responsibilities should consider for each job. Up to six specific types of responsibilities: Operational, Supervisory, Project Management including Strategic Projects, Financial, Administrative and Behavior. Emphasis must be placed on the value/result that is added by the Responsibility and not on the how it is done. The how is managed through improvement and or accountability sessions.
For each Primary Responsibilities documented Performance Indicators must be identified and documented. Emphasis must be placed on assuring that Performance Indicators objectively measure cost effectiveness and must be under the control or significant influence of the Job Position. Performance Indicators should consider the following types of Indicators; Quantitative, Qualitative, Average Time and Efficiency.
For each Performance Indicator identified and documented the minimum performance expectation must be objectively identified and documented.
Minimum performance expectations must be fair and obtainable while maintaining a favorable growth-oriented challenge/skill balance.
Expectations should consider at least 3 types of expectations; Greater than or Equal to, Equal to and Less than or Equal to. (≥, =, ≤)

Data gathering and Analysis when performing an evaluation.

The data used to objectively measure the results per month must be accurate. In order to facilitate this process. The instant invention uses various tools, among others:
a. Required Reports Compliance Register
b. Assigned Projects Compliance Register
c. Required Tasks Compliance Register

Within the instant invention the word Accountable is defined as:
The requirement or obligation of an employee to gather data regarding results obtained, analyze results obtained, compare results obtained vs. minimum required expectations, account for and fully accept responsibility for all results obtained on a periodic basis.

On a Monthly basis the employee is required:
a. to gather accurate and updated data of all the results which correlates to for all Systemic Performance Indicators.
b. enter the data of the results obtained for all indicators in extremely specific tables and graphs.
c. verify if all data is accurate.
d. entering the data of the results obtained for all indicators in extremely specific tables and graphs is fundamental for the individual introspection and reflection process Visual Impact.
e. after data is entered the employee must analyze each graph and determine the level of execution vs the expected results and the indicator trend. VISUAL COMMUNICATION—The process is highly visual, lending to a much higher level of understanding by both supervisor and supervised, and promotes a more effective communication and delegation process.
f. for indicators not in compliance the employee must identify and document suggested corrective actions.
g. Corrective actions must be agreed upon and documented
h. Agreed upon Corrective actions from prior review sessions not executed will result in disciplinary actions.

On a Monthly basis the supervisor is required to:

require that every assigned employee fully and accurately completes the Employee Profile on-time
a. analyze and validate the accuracy of the data.
b. analyze and validate the corrective actions documented by the employee for indicators not in compliance.
c. document all agreements regarding corrective actions.
d. if no corrective actions were identified and documented by the employee for indicators not in compliance the supervisor must ask for possible actions to improve the non-complying indicators, if no actions are identified the supervisor can suggest improvement ideas.

### The Periodic Accountability Process

a. at periodic pre-established intervals, no less than four times a year, the supervisor is required to meet with the employee and establish an employee-lead performance-focused dialogue using the 94/6 model.
b. the supervisor must assure that the employee does the great majority of the talking during the review process we recommend 94%, this drastically promotes employee's accountability.
c. during the performance focused dialogue, the employee must review all indicators and provide relevant information to further improve performance if needed
d. the supervisor must ask the employee if any further support, training, or assistance is needed to further improve performance.
e. the supervisor must provide recognition when indicators improve or at optimum levels.

The instant invention Performance Management Business Method uses individual and aggregate results information to identify organizational opportunity areas for establishing Individual & Systemic Results Focused Trainings and Continuous Process Improvement Initiatives.

The spirit of continually improving results through directed tangible results oriented initiatives serves as an incredible platform for the development and deployment of LATERAL KNOWLEDGE TRANSFER and BUSINESS INTELLIGENCE initiatives to create aggregate best practices between multiple elements like people with same positions, people with different positions with similar performance indicators, both within a department or organization all the way to between divisions operating independently in different locations throughout the world.

Results and Accountability System Performance Management Business Method is a unique and objective self-assessment performance management system that is created to promote consistent, aligned organizational results. This is achieved by provoking periodic individual introspection and accountability for all results obtained from both management and the employee or team member.

Leadership's role in Performance Management is to continuously improve the cost effectiveness of all processes in the system and to promote an inspiring work environment for all.

As noted several elements make this process unique. Several of them are a staple in themselves, weaving a systemic and synergistic process that integrates both the strategic and operational portions of the leadership and management processes in a practical easy to teach and delegate and proven system makes this work unique.

The instant invention has improved on this system and it requires a conscious decision and input from both management and the employee.

Unique features of the instant invention are:
The instant invention addresses the enormous subjectivity in the traditional External Judgment Based Performance Evaluation Process for all organizational levels. The objective Process is capable of stimulating the employee's self-awareness, introspection and accountability of their results using actual results, math, and visual aids. All existing systems are subjective and focused on the judgment of the one who evaluates, which for many can result in destroying their passion (“engagement”) of the employee. In addition the organizations do not effectively train the supervisors so that they understand the goals and objectives of the organization and have not mastered the skill of effective dialogue.
The instant invention Business Model creates a shared set of criteria to guide the effectiveness of the work process, and a route to improve results in a constructive, non-destructive fashion.

The result is that the employee that receives performance input usually mentally or verbally justify their actions and noncompliance with expected results. The traditional Performance Evaluation Processes do not force effective, objective, and periodic dialogue and does not promote real “accountability” which is to assume responsibility and be held accountable for the results obtained (good or bad) and do not promote Mission, Vision, and Systemic integration.

Critical features on the instant invention that makes it attractive to the user include the method of clarifying expected results for all Primary Responsibilities that must be documented as expected results using an extremely specific method; verb, who or what receives the verb and expected results. Being able to establish fair, just, and controllable Indicators and minimum expectations that promote the employee or individuals understanding of results achieved aligned to all Primary Responsibilities assigned. The periodic review process that almost completely inverts the focus from the supervisor to the employee. And the benefit of having access to aggregate organizational data that inspires the spirit of continually improving results through directed tangible results oriented initiatives that serve as an incredible platform for the development and deployment of LATERAL KNOWLEDGE TRANSFER and BUSINESS INTELLIGENCE initiatives to create aggregate best practices between multiple elements like people with same positions, people with different positions with similar performance indicators, both within a department or organization all the way to between divisions operating independently in different locations throughout the world.

The instant invention proprietary Aggregate Data collected from all Customer Organizations is used to analyze and or experiment with positive and negative pattern correlations between methods and practices with both positive and negative results in order to create and commercialize both developed knowledge and data trends based forecast scenarios for both customers and/or industries developed as a result of Artificial Intelligence (AI) and data science application to all markets including and not limited to Profit, Non Profit, Government and Academic Organizations, Users and our own Research and Publications

Key Concepts and Requirements for optimized implementation include organizational input, management input and a system that allows input for the employee.

The instant invention requires that the organization top management must determine and document the organization's Mission, Vision, Strategic Objectives, Expected Behaviors and Systemic Performance Indicators.

The Mission Statement must be documented as expected results using an extremely specific method; verb, who or what receives the verb and expected results. A Mission Statement containing no more than 15 words is preferred. Key concepts or specific words must be clearly explained to avoid different interpretations of the Mission Statement. Emphasis must be placed on the value that is added by the organization and not on the how it is added. High level Performance Indicators for the Mission Statement must be determined and documented.

The Vision Statement must be identified and documented. A Vision Statement containing no more than 50 words is preferred. It must be extremely specific high-level. Specific Vision Results/Strategic Objectives for each entity/employee should be determined and documented. The high-level results for the Vision statement can be bulleted or paragraphs. The documentation must be targeted so as to inspire people to want to achieve them. For each extremely specific high-level Vision Results/Strategic Objectives, Performance Indicators must be determined and documented.

For each extremely specific high-level Vision Results/Strategic Objectives a highly detailed specific action plan must be established and documented (Assigned Projects Compliance Register). The clarity of the documentation is important to the results and the ability to provide all users with a clear understanding of the Vision and Mission.

Organizational Values and Principles must be identified and documented. The system is flexible, but it is recommended that no more than 12 be defined. Each value and/or principle should be operationalized by stating expected observable behaviors for each, so everyone understands what specific behaviors are expected from people that follow those values and principles. Consider having at least two sets of behaviors that reflect the required culture: managers and non-managers. The intent is to not provide a mechanism where there are two rulers, but for having samples that any employee can relate to no matter where they are assigned to work.

The instant invention emphasis is placed on assuring that they are correctly documented as behaviors and not values. Performance Indicators must be identified and documented for Expected Behaviors compliance. This solves the eternal conflict of confused expectations at performance evaluation time.

For each Job Position the instant invention documents the high-level contribution of each job with respect to the Mission. The high-level contribution must be documented as expected results using an extremely specific method; verb, who or what receives the verb and expected results. This process cannot be taken as a simple event, since it starts by landing exactly why, in terms of mission-value based systemic-organization focused perspective, this position is needed.

The instant invention documents Primary Responsibilities must be documented as expected results using an extremely specific method; verb, who or what receives the verb and expected results.

The instant invention promotes effective recruiting and Skill Gap Analysis for each Primary Responsibility. The instant invention documents the essential skills and technical capabilities necessary to fulfill them effectively must be identified and documented.

The instant invention documents the essential skills and technical capabilities necessary to fulfill the Primary Responsibilities an objective manner to evaluate each one must be identified and documented.

The instant invention documents each objective manner to evaluate the skills and technical capabilities the minimum grade required to validate the level of mastery must be identified and documented. This step is of the utmost importance and should be used to recruit effectively and train when opportunity areas are identified in Skill Gap Analysis

With respect to Responsibilities the instant invention provides the method of documenting various specific types of responsibilities, but not limited to: Operational, Supervisory, Project Management including Strategic Projects, Financial, Administrative and Behavior. Emphasis must be placed on the value/result that is added by the Responsibility and not on the how it is done. The how is managed through improvement and or accountability sessions.

For each Primary Responsibilities the instant invention provides the method of documenting Performance Indicators. Performance Indicators must be identified and documented. Emphasis must be placed on assuring that Performance Indicators objectively measure cost effectiveness and must be under the control or significant influence of the Job Position.

Performance Indicators should consider the following types of Indicators; Quantitative, Qualitative, Average Time and Efficiency.

For each Performance Indicator identified and documented the minimum performance expectation must be objectively identified and documented. Minimum performance expectations must be fair and obtainable while maintaining a favorable growth-oriented challenge/skill balance

Expectations should consider at least 3 types of expectations; Greater than or Equal to, Equal to and Less than or Equal to. (≥, =, ≤)

The instant invention provides Data gathering and Analysis.

The data used by the instant invention to objectively measure the results per month must be accurate. In order to facilitate this process, the system use various tools, among others;
Required Reports Compliance Register
Assigned Projects Compliance Register
Required Tasks Compliance Register

Examples of the data collection method used by the instant invention are shown below:

| Required Reports Compliance Register | | | | Month/Year | Total | On |
|---|---|---|---|---|---|---|
| Report | Frequency | Restricciones | Due Date | | Required | Time |
| 1 | | | | | | |
| 2 | | | | | | |
| 3 | | | | | | |
| 4 | | | | | | |

Total Reports Required
Total Reports on Time
% of Reports on Time

Required Tasks Compliance Register

| | | | | | | | | | |
|---|---|---|---|---|---|---|---|---|---|
| | | | | Date: | | | Complied | | |
| Owner | | | | Received | Due | Completed | YES or | | Days LAte |
| NUM | Action | Promebeo a: | Assigned to: | Date | Date | Date | No? | Status | (+o−) |

Assigned Projects Compliance Register

| | Estimated | Actual | % of Budget | | Date | Completed |
|---|---|---|---|---|---|---|
| Project Name/Description | Budget | Expense | vs Expense | End Date | Completed | Yes or No? |
| 1 | | | | | | |
| 2 | | | | | | |
| 3 | | | | | | |
| 4 | | | | | | |
| 5 | | | | | | |
| 6 | | | | | | |

| | |
|---|---|
| Total Estimated Budget | Total Projects Assigned |
| Total Actual Expense | Projects Completed on Time |
| % of Budget vs Expense | % of Projects Completed on Time |

The performance review process of the instant invention. The process of the instant invention makes the employee truly accountable.

With respect to the disclosure and the instant invention the term accountable is defined as:

The requirement or obligation of an employee to gather data regarding results obtained, analyze results obtained, compare results obtained vs. minimum required expectations, account for and fully accept responsibility for all results obtained on a periodic basis.

On a monthly basis the employee is required to use the instant invention to:
Gather accurate and updated data of all the results obtained for all indicators;
Enter the data of the results obtained for all indicators in extremely specific tables and graphs;
Verify if all data is accurate;
Entering the data of the results obtained for all indicators in extremely specific tables and graphs is fundamental for the individual introspection and reflection process;
   The instant invention provides the employee with a method to track performance and utilizes a visual impact presentation means to convey the results. The system utilizes the GPS or IPS location to provide the system with location information for the employee so that the employee is associated with the correct work location or division. This provides the system the ability to aggregate employees and pair their results to the applicable goals.

After the data is entered into the instant invention the employee must analyze each graph and determine the level of execution vs. the expected results where the instant invention provides an indicator trend. The instant invention promotes visual communication which is the process where information is translated into a highly visual display, lending to a much higher level of understanding by both supervisor and the supervised/employee. Visual communication of data promotes a more effective communication and delegation process.

The instant invention highlights those indicators not in compliance and the employee must identify and document suggested corrective actions.

The instant invention formalizes the corrective actions which must be agreed upon and documented.

The instant invention can also provide a method to track agreed upon corrective actions from prior review sessions that were not executed. The system provides the method to document and convey any disciplinary actions due to noncompliance.

The instant invention forces compliance. On a monthly basis the supervisor is required to:
Require that every assigned employee fully and accurately completes the Employee Profile on-time;
Analyze and validate the accuracy of the data;
Analyze and validate the corrective actions documented by the employee for indicators not in compliance;
Document all agreements regarding corrective actions;
If no corrective actions were identified and documented by the employee for indicators not in compliance the supervisor must ask for possible actions to improve the non-complying indicators, if no actions are identified the supervisor can suggest improvement ideas;
The instant invention has a periodic accountability process.

At periodic pre-established intervals, no less than four times a year, the supervisor is required to meet with the employee and establish an employee-lead performance-focused dialogue using the instant invention.

The supervisor must assure that the employee actively participates in the process and must do the majority of the talking during the review process. A good target is for the employee to provide at least 94% of the verbal communication during the session. This level of participation promotes employee's accountability. The agreements and commitments product of the performance review session is documented in the system.

During the performance focused dialogue, the employee must review all indicators and provide relevant information to further improve performance if needed which is documented in the system.

The supervisor must ask the employee if any further support, training, or assistance is needed to further improve performance which is documented in the system.

The supervisor must provide recognition when indicators improve or at optimum levels which is documented in the system.

The instant invention performance management business method uses individual and aggregate results information to identify organizational opportunity areas for establishing individual & systemic results focused trainings and continuous process improvement initiatives.

The spirit of continually improving results through directed tangible results oriented initiatives serves as an incredible platform for the development and deployment of lateral knowledge transfer and business intelligence initiatives to create aggregate best practices between multiple elements like people with same positions, people with different positions with similar performance indicators, both within a department or organization all the way to between divisions operating independently in different locations throughout the world.

The instant invention web-based software presents data to be used solely by the interpretation of the end user and or management, with the intent to improve individual and collective performance.

The instant invention web-based application designed to automate the performance management business method of the instant invention and provides unique tools and functionalities that facilitate and enhance, objective self-assessment and supervisory tasks required to promote consistent, aligned, and organizational results.

Some of the applications benefits among others:
No knowledge of excel required. The system automates all the data entry capture and conversion.
The instant invention updates the graphs manually from month to month.
The instant invention allows the supervisor and employee to see individual results summarized monthly or as needed.
The instant invention allows supervisor and employee to see your individual results in a summary form accumulated per year.
The instant invention allows supervisor and employee to see the results of your individual employees monthly.
Allows supervisor to see the results of their individual employees cumulatively per year.
Allows supervisor to see your department's aggregated results.
The instant invention calculates performance and analyzes monthly conditions.
Currently the instant invention provides automatically computer created action-oriented notifications using our business model specific agreed upon expectations based algorithms to promote employee introspection and a clearer self-understanding of results vs expectations and performance execution trends. Some of the action-oriented notifications, but not limited to are:
   i. In Compliance and in Optimal Condition.
   ii. In Compliance and Exceeding Expectations.
   iii. In Compliance Exceeding Expectations and In Optimal Condition.
   iv. In Compliance Exceeding Expectations and has an Improving Trend.
   v. In Compliance Exceeding Expectations and has No Change in Trend.
   vi. In Compliance Exceeding Expectations, But Trend is Decreasing/Getting Worse.
   vii. In Compliance and has an Improving Trend.
   viii. In Compliance and has No Change in Trend.
   ix. In Compliance, But Trend is Decreasing/Getting Worse.
   x. Not In Compliance but shows a tendency to improve.
   xi. Not In Compliance and has No Change in Trend.
   xii. Not In Compliance and Trend is Decreasing/Getting Worse.
The instant invention sends supervisor data status notifications, but not limited to are:
   Primary Responsibilities created and pending approval.
   Performance Indicators and expectations created and pending approval.
   Monthly results data entered and pending approval.
   Revision meeting reminders, among others.
The instant invention provides a clear generated traceable method to document performance review sessions, that includes but not limited to:
   i. Results obtained,
   ii. Agreements and Commitments.
      1. Document actions in a computer generated and tracked formal follow up process.
   iii. Recognitions.
   iv. Both formal and informal disciplinary actions as validated and framed by users own legal counsel.
Automatically informs any of the above to relevant parties as established or required.

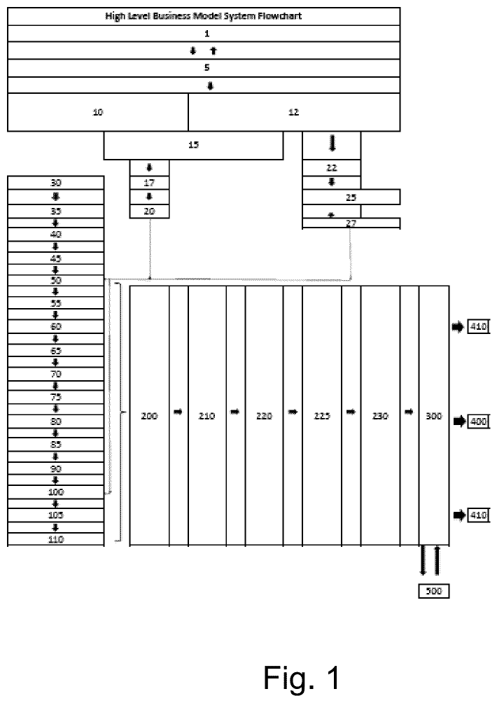

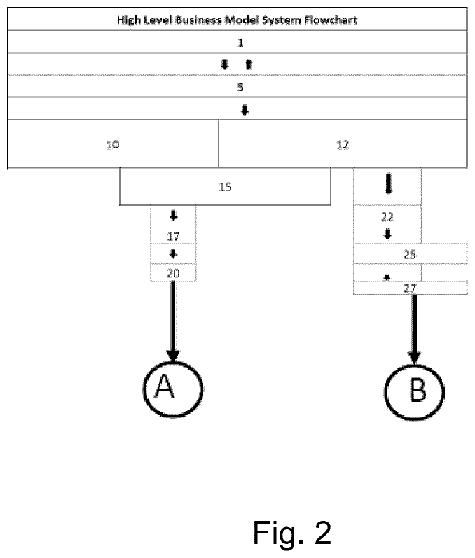

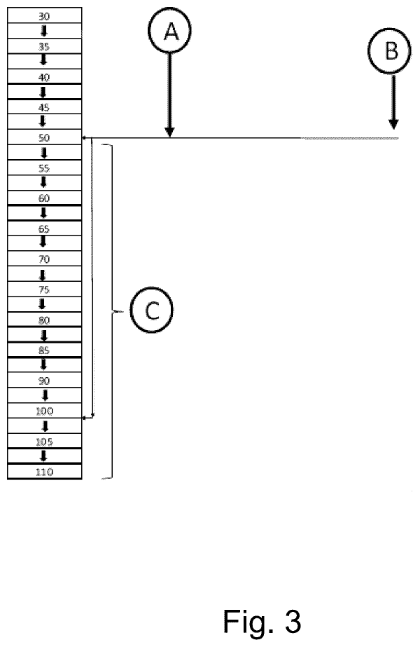

Referring now to the drawings FIGS. 1, 2, 3 and, 4 there is shown a flow chart of the instant invention. The system can use an automated or a manual process. The management of the organization inputs the organizational mission identified and documented using the methodology step 10 and the organizational vision identified & documented (no more than 12 extremely specific high-level vision expected strategic objectives results step 12.

The next step the organization inputs the organizational values and principles that promote the fulfilment of the organizations mission & vision must be identified, documented and operationalized by stating expected observable behaviors for each (no more than 12 for at least 2 levels) step 15 when steps 10 and 12 have been completed. The system captures the ISP and or Email and or GPS location of the management and records it to the instant invention and pairs it with the site so that the correct site information is used in setting up both mission and vision as well as the management employees' information.

The management using the instant invention informs all the employees of the organizational values and principles and organizations mission and vision in step 17 through the use of the instant invention.

The management then using the instant invention assigns to all responsibilities to all levels minimum step 20. There must be at least 2 levels in the organization to utilize the instant invention. The instant invention then passes the control to step 50.

After step 12 is completed then the management adds the strategic focus areas identified & documented in step 22.

The management using the instant invention documents the strategic initiatives and minimum expected results for strategic focus areas identified & documented step 25. These are assigned to the appropriate manager in step 27. The instant invention then passes the control to step 50.

Once step 27 and step 20 are completed then the instant invention has control of the process at step 50 and step 100.

Step 30 of the instant invention the core organizational processes required to fulfill the mission are identified & documented and loads the information into the instant invention.

Step 35 of the instant invention the core organizational processes expected results, performance indicators and minimum levels of expected execution identified & documented by department or process (by process highly recommended) and loads the information into the instant invention.

Step 40 of the instant invention the skills and competencies necessary to effectively achieve the core organizational processes expected results identified & documented and loads the information into the instant invention.

Step 45 of the instant invention recruitment effectively executed to obtain the candidate with the skills and competencies necessary to effectively achieve the core organizational processes expected results and loads the information into the instant invention.

Step 50 of the instant invention receives information from steps 27 and 20. The instant invention then assigns primary responsibilities to managers for all core organizational processes and loads the information into the instant invention. The system captures the ISP and or Email and or GPS location of the management and records it to the instant invention and pairs it with the site so that the correct site information is used in setting up both mission and vision as well as the management employees' information.

The ISP and or Email and or GPS related information ensures that the manager is associated with the correct location of the facility and that the correct goals and visions are also associated with the manager and the employees. The system has a table of ISP and or Email and or GPS locations versus facility or department which is used to confirm the data entry of the location information entered by the management and the employee. Therefore, the data is verified so that it is correct and proper goals are set.

Step 55 of the instant invention receives information from step 50 and the manager reviews primary responsibilities, performance indicators and minimum levels of expected execution and negotiates corrective actions if necessary and loads the information into the instant invention.

Step 60 of the instant invention receives information from step 55 and the manager adds primary responsibilities using the “VWWER” methodology and performance indicators if necessary to better understand the level of execution and loads the information into the instant invention. The VWWER: Verb-Who or What-Expected Results.

Step 65 of the instant invention receives information from step 60 and manager gets approval of added performance indicators if applicable to synchronize and assure unity of purpose and loads the information into the instant invention.

Step 70 of the instant invention receives information from step 65 and manager assigns primary responsibilities to supervisors if applicable and loads the information into the instant invention.

Step 75 of the instant invention receives information from step 70 and supervisor reviews primary responsibilities, performance indicators and minimum levels of expected execution and negotiates corrective actions if necessary and loads the information into the instant invention.

Step 80 of the instant invention receives information from step 75 and Supervisor adds Primary Responsibilities using the “VWWER” Methodology and Performance Indicators if Necessary to better understand the level of execution and loads the information into the instant invention. VWWER* Verb-Who or What-Expected Results.

Step 85 of the instant invention receives information from step 80 and supervisor gets approval of added performance indicators by supervisor if applicable to synchronize and assure unity of purpose and loads the information into the instant invention.

Step 90 of the instant invention receives information from step 85 and supervisor assigns primary responsibilities to employees if applicable and loads the information into the instant invention.

Step 100 of the instant invention receives information from step 90 and employee reviews primary responsibilities, performance indicators and minimum levels of expected execution and negotiates corrective actions if necessary and loads the information into the instant invention.

Step 105 of the instant invention receives information from step 100 and employee adds performance indicators if necessary to better understand the level of execution and loads the information into the instant invention.

Step 110 of the instant invention receives information from step 105 and employee gets approval of added performance indicators by supervisor if applicable to synchronize and assure unity of purpose and loads the information into the instant invention.

The information gathered and recorded during steps 50 to 110 is passed to step 200 where the employee is empowered and execution of the performance and corrective actions is permitted.

Step 210 pre-established periodic system objectives self-evaluation process are recorded (up to six levels of responsibilities) are documented in the instant invention.

Step 220 recognition and or improvement process (recognitions and improvement commitments documented in the instant invention).

Step 225 commitments follow up in next pre-established periodic objective self-evaluation process (up to six levels of responsibilities) are documented in the instant invention.

Step 230 execution consequences with predictability and respect (recognitions, disciplinary actions, and transfers if applicable) are documented in the instant invention.

Step 300 is the use of artificial intelligence aided pattern recognition and or improvement opportunities in process and systemic effectiveness, leadership effectiveness and strategic effectiveness. This utilizes step 500 which utilizes the instant invention proprietary aggregate data collected from all customer organizations used to analyze and or experiment with positive and negative pattern correlations between methods and practices with both positive and negative results in order to create and commercialize both developed knowledge and data trends based forecast scenarios for both customers and/or industries developed as a result of historical correlations and/or artificial intelligence (AI), business intelligence based business knowledge, and data science application to all markets including and not limited to profit, non-profit, government and academic organizations, users and our the instant invention research and publications.

Step 410 the instant invention produces the organizational development plan.

Step 400 the instant invention produces the processes development plan.

Step 420 the instant invention produces the individual development plan.

The instant invention can be summarized as a Performance Management Business Method comprising of the steps:
An at least one manager documents an organization's mission;
The at least one manager documents an organization's vision;
The at least one manager documents an organization's strategic objectives;
The at least one manager documents an organization's expected behaviors;
The at least one manager documents an organization's Systemic Performance Indicators;
The at least one manager conveys the organizations mission, the organizations vision, the organizations Strategic Objectives, the organizations expected behaviors, the organizations Systemic Performance Indicators to an at least one employee;
The at least one employee assembles data which correlates to the Systemic Performance Indicators;
The at least one employee provides input for the Systemic Performance Indicators and documents the at least one employee input;
The at least one employee reviews the Systemic Performance Indicators and analyzes the Systemic Performance Indicators and documents the review of the Systemic Performance Indicators;
The at least one employee identifies and documents suggested corrective actions for the Systemic Performance Indicators that are not in compliance with agreed to the Systemic Performance Indica;
The at least one manager and the at least one employee meet at a meeting to review the Systemic Performance Indicators;
The at least one manager and the at least one employee agreed upon and documented the Systemic Performance Indicators results and corrective actions for the Systemic Performance Indicators at the meeting.
The at least one manager and the at least one employee meet at a next meeting and review the Systemic Performance Indicators results and corrective actions for the Systemic Performance Indicators;
The at least one manager and the at least one employee agreed upon and documented the Systemic Performance Indicators results and agreed upon corrective actions for the Systemic Performance Indicators at the next meeting;
At the next meeting the agreed upon corrective actions from prior review sessions not executed will result in disciplinary actions;
The instant invention using Business Intelligence provides relevant and result hard data-based facts for producing an Organizational Development Plan;
The instant invention using Business Intelligence provides relevant and result hard data-based facts for producing Processes Development Plans; and
The instant invention using Business Intelligence provides relevant and result hard data-based facts for producing Individual Development Plans.

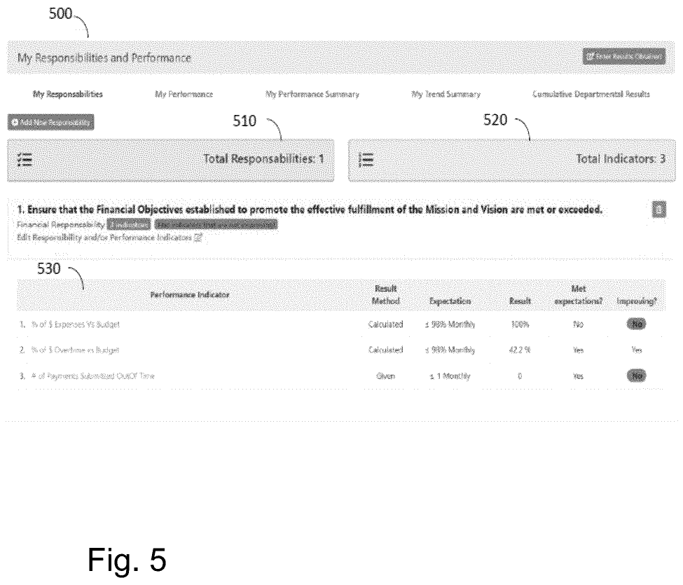

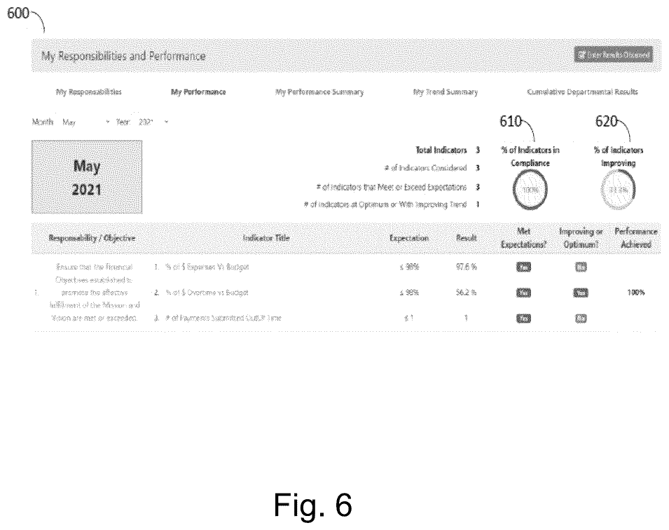

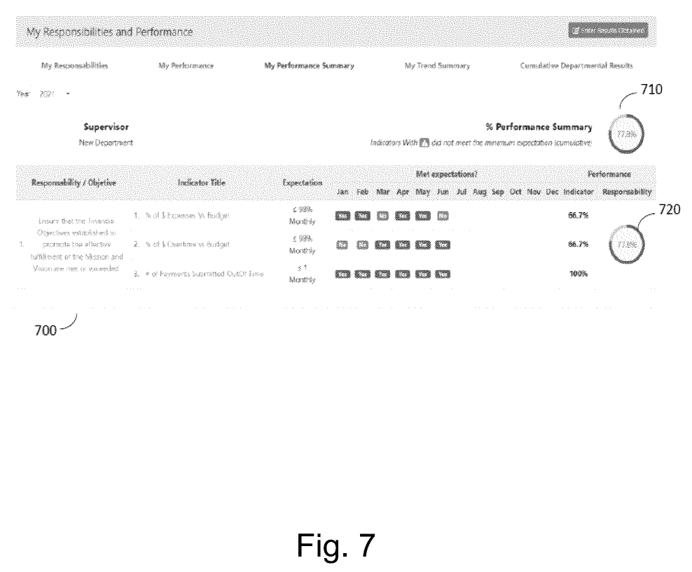

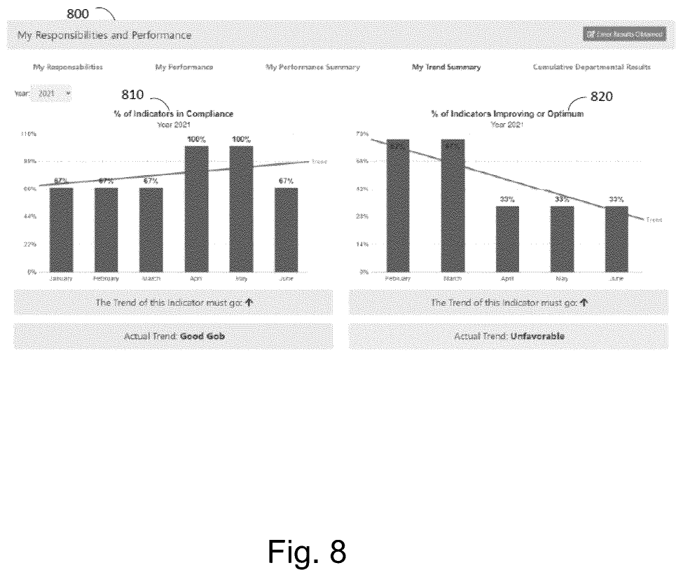

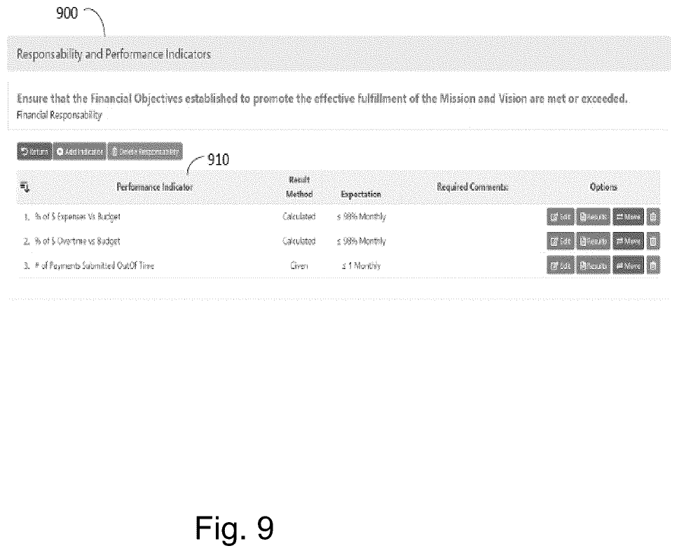

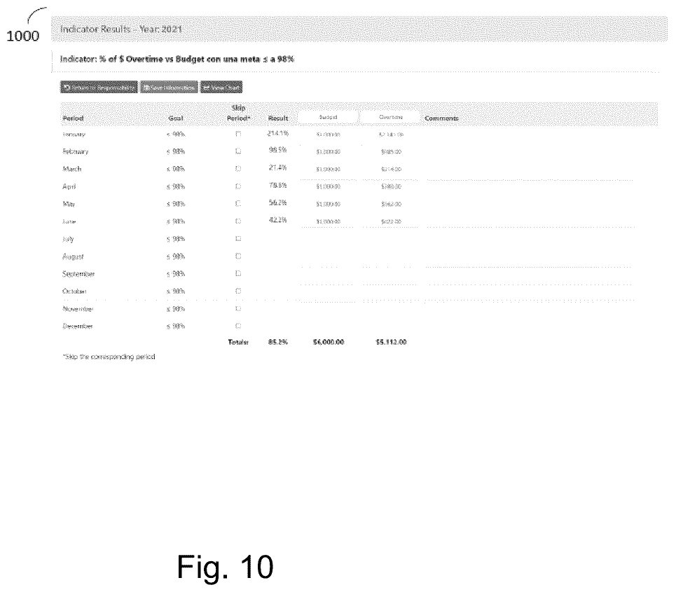

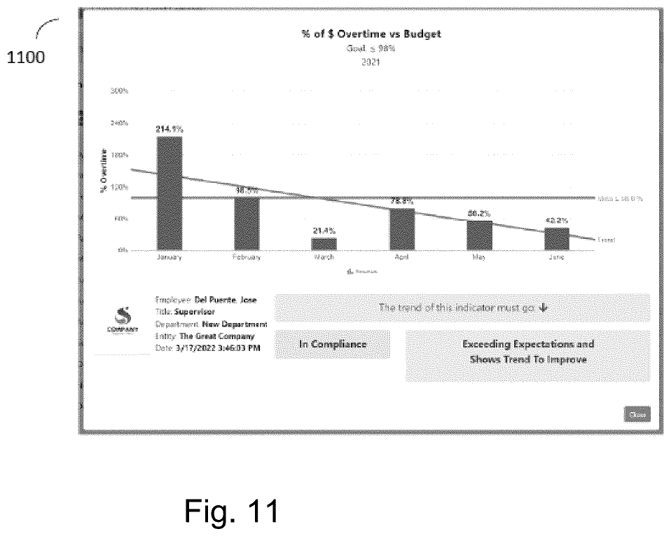

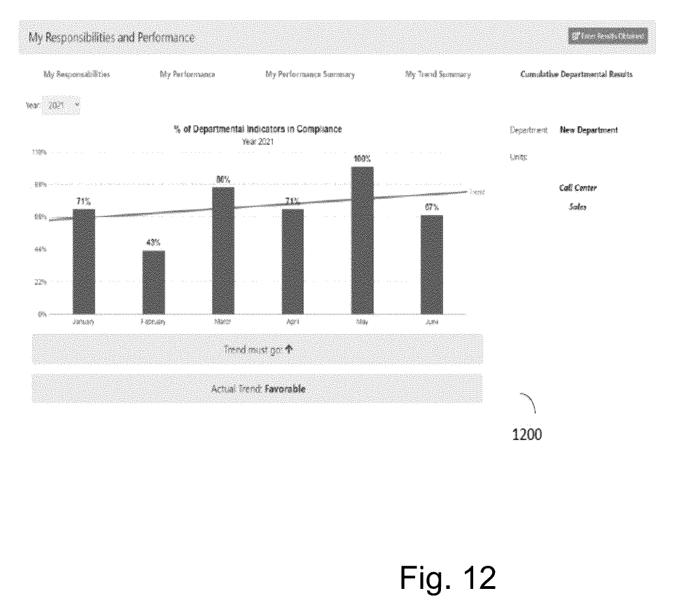

The instant invention can be further be summarized as a Performance Management Business Method that is performed using a supervisory computer system comprising of the steps:
The supervisory computer system being connected to at least one management computer with the management application and at least one employee computer with the employee application;
The supervisory computer having at least one known location associated with a ISP and or Email and or GPS location and the supervisory computer having a supervisory computer database that stores at least one known location data at least one manager data and at least one employee data;
The at least one management computer having a management ISP and or Email and or GPS module and at least one employee computer having an employee ISP and or Email and or GPS module;
The at least one management computer sends or records the ISP and or Email and or GPS location of the at least one management computer to the supervisory computer system and the supervisory computer system the ISP and or Email and or GPS location of the at least one management computer to determine at least one known location and the supervisory computer database stores the at least one known location data with the at least one manager data
Management using the at least one management computer system with the management application documents an organization's mission on the at least one management computer system;
Management using the at least one management computer system with the management application documents the organization's vision;
Management using the at least one management computer system with the management application documents the organization's strategic objectives;
Management using the at least one management computer system with the management application documents the organization's expected behaviors;
Management using the at least one management computer system with the management application documents the organization's Systemic Performance Indicators. The management can also review the overall performance of the organization or department using screen shown in FIG. 9 responsibility detail, screen shown in FIG. 10 indicator results, screen shown in FIG. 11 result chart and screen shown in FIG. 12 department results.
Management using the at least one management computer system with the management application transfers the organizations mission, the organizations vision, the organizations strategic objectives, the organizations expected behaviors, the organizations Systemic Performance Indicators to the supervisory computer system;
The supervisor computer system transfers the organizations mission, the organizations vision, the organizations Strategic Objectives, the organizations expected behaviors, the organizations Systemic Performance Indicators to at least one employee computer;
The at least at least one employee computer sends the ISP and or Email and or GPS location of the at least at least one employee computer to the supervisory computer system and the supervisory system compares the ISP and or Email and or GPS location of the at least at least one employee computer and determines a known location stored in the supervisor computer system database stores the at least one known location data with the at least one employee data and downloads specific known location information stored in the supervisor computer system in the at least on employee data;
The at least one employee using the at least one employee computer system assembles data which correlates to the Systemic Performance Indicators and using the at least one employee computer with the employee application transfers the data which correlates to the Systemic Performance Indicators to the supervisor computer system and the supervisory computer system stores the data which correlates to the Systemic Performance Indicators to the supervisory computer database;
The at least one employee using the at least one employee computer system provides employee input data for the Systemic Performance Indicators and documents employee input data and the at least one employee computer system stores the employee input data to the Systemic Performance Indicators to the supervisory computer database;
The at least one employee reviews the Systemic Performance Indicators on the supervisory computer database using the at least one employee computer system and analyzes the Systemic Performance Indicators and documents the review of the Systemic Performance Indicators using the at least one employee computer system and stores the Systemic Performance Indicators to the supervisory computer database;
The at least one employee using the at least one employee computer system identifies and documents suggested corrective actions for the Systemic Performance Indicators that are not in compliance with the agreed to the Systemic Performance Indicators; The employee can review information using the at least one employee computer system such as screen shown in FIG. 5 main responsibilities screen 500 which shows total responsibilities 510, total indicators 520 and performance indicators 530, screen shown in FIG. 6 Performance screen 600 which shows percent of indicators in compliance 610 and percent of indicators improving 620, screen shown in FIG. 7 Performance summary screen 700 which shows percent performance summary 710 and responsibility percentage 720; screen shown in FIG. 8 performance trends screen 800 which shows percent indicators in compliance 810 and percent indicators in improving compliance 820; screen shown in FIG. 9 responsibility detail screen 900 which shows performance indicators 910; screen shown in FIG. 10 indicator results 1000, screen shown in FIG. 11 result chart 1100 showing the result performance over time and screen shown in FIG. 12 department results 1200.

The system may include corrective actions which are specific to Systemic Performance Indicators. The system may integrate a specifically prepared and painless methodology that balances clear definition of responsibilities with a focus on achieving process improvement-based results, ensuring that the employee is aware of their specific tasks and are continuously driven to improve their processes and outcomes. The system may incorporate a participative performance evaluation process, allowing employees to assess their own performance, fostering greater involvement and motivation, making the system particularly effective for managing off-site and hybrid workers. The system may implement continuous process improvement for ensuring that employees and the organization consistently work towards higher performance standards and better results.

The management and the employee using the at least one management computer system with the management application meet at a meeting to review the Systemic Performance Indicators stored in the supervisory computer database. The manager and the employ can look at screen shown in FIG. 9 Department results to see how the employee is doing compared to the overall department;
The management and the employee agreed upon and documented the Systemic Performance Indicators results and corrective actions for the Systemic Performance Indicators at the meeting and using the at least one management computer system with the management application store Systemic Performance Indicators in the supervisory computer database;
The employee and management meet at a next meeting and review the Systemic Performance Indicators results and corrective actions for the Systemic Performance Indicators stored in the supervisory computer database using the management computer;
The management and the employee agreed upon and documented the Systemic Performance Indicators results and agreed upon corrective actions for the Systemic Performance Indicators stored in the supervisory computer database using the management computer at the next meeting;
The supervisory computer uses Artificial Intelligence and Aided Pattern Recognition and to analyze and or experiment with positive and negative pattern correlations between methods and practices with both positive and negative results in order to create knowledge and data trends;
At the next meeting the agreed upon corrective actions from prior review sessions not executed will result in disciplinary actions;
The instant invention using Business Intelligence provides relevant and data-based facts for producing an Organizational Development Plan;
The instant invention using Business Intelligence provides relevant and data based facts for producing Process Development Plans; and
The instant invention using Business Intelligence provides relevant and data based facts for producing Individual Development Plans.

The Performance Management Business Method wherein the employee input comprises task performance, quality of output, on time results, new client recruitment, response times and service times.

The Performance Management Business Method wherein the corrective actions are specific to Systemic Performance Indicators.

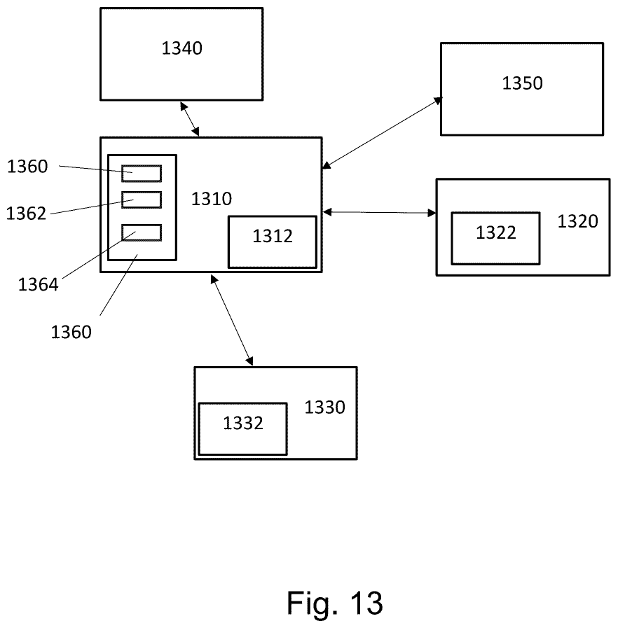

One embodiment of a system for using a Performance Management Business Method is shown in diagram 1300 of FIG. 13. The system is for applying performance management in a business method. The system includes a supervisory computer 1310 having at least one known location 1340 associated with an ISP and or Email and or GPS location and a supervisory computer database 1360 that stores at least one known location data 1361 at least one manager data 1362 and at least one employee data 1364 wherein the supervisory computer 1310 includes a supervisory algorithm 1312 for allowing a manager to document an organization mission, an organization vision, strategic objectives of an organization, expected behavior within the organization, and systemic performance indicators. The system includes at least one management computer 1350 in communication with the supervisory computer 1310 and includes a management application 1352, a management ISP and or management Email and or management GPS module 1356. The management computer includes a manager algorithm for allowing the at least one manager to convey the organization mission, the organization vision, the organization strategic objectives, the organization expected behaviors, and the organization systemic performance indicators to an at least one employee. The system includes at least one employee computer 1320 in communication with the supervisory computer 1310 and includes an employee application, an employee ISP and or employee Email and or employee GPS module wherein the at least one employee computer includes an employee algorithm 1322 for guiding the at least one employee to assemble systemic performance indicators data and to provide a review of the systemic performance indicators. The employee algorithm 1322 analyzes the Systemic Performance Indicators and document the review of the Systemic Performance Indicators and identifies and documents suggested corrective actions for Systemic Performance Indicators that are not in compliance with agreed to Systemic Performance Indicator. The GPS modules allow the supervisory computer to keep track of the location of any number of management computers or employee computers. The ability to keep track of the managers or employees is useful in ensuring all employee data and all management data as accurate by either monitoring full time or by periodic checks of the location data by the GPS modules.

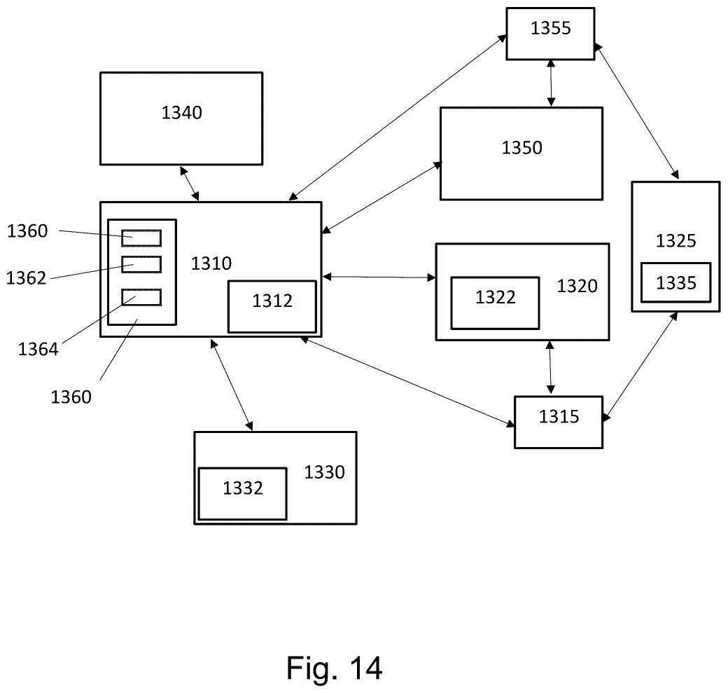

As shown in FIG. 14, one aspect of the embodiment shown in FIG. 13 provides a GPS device designed specifically for tracking the location of a manager smart device 1355 and the employee smart device 1315. This GPS device may include various components that work together to accurately determine and monitor the position of the manager smart device 1355 and the employee smart device 1315. The GPS device may be attached to the manager smart device 1355 and the employee smart device 1315, enabling real-time tracking of the manager smart device 1355 and the employee smart device 1315 location. The GPS device may utilize satellite signals to determine the precise location of the manager smart device 1355 and the employee smart device 1315 and may relay this information to a user or cloud application through a variety of means, such as a mobile application or a web-based platform. In some cases, the GPS device may also include features that allow for historical tracking data to be stored and accessed, providing a record of the manager smart device 1355 and the employee smart device 1315 movements over time. This GPS device may offer a solution for individuals who frequently misplace their manager smart device 1355 and the employee smart device 1315 providing a convenient and efficient means of locating the item when it is not immediately visible or accessible.

In some embodiments the manager smart device 1355 and the employee smart device 1315 can have a GPS location device. The GPS location can be used as a second tier security method where as the manager smart device 1355 and the employee smart device 1315 send the GPS location determined from the respective GPS location device and a cloud application 1335 checks the GPS location transferred from the manager smart device 1355 and the employee smart device 1315 with a sanction list of GPS locations on the cloud server and if the GPS location sent from the manager smart device 1355 or the employee smart device 1315 is contained in the sanction list of GPS locations on the cloud server 1325 then the cloud application 1335 allows the manager smart device 1355 or the employee smart device 1315 to initiate the transfer of information. If the GPS location sent by the manager smart device 1355 or the employee smart device 1315 is not contained on the sanction list of GPS locations on the cloud server 1325 then the cloud application 1335 does not allows the manager smart device 1355 or the employee smart device 1315 to initiate the transfer of information.

The system can also utilize a security system based on a GPS location of the user device attempting to communicate with the system. The device signing into the system or client node sends the GPS coordinates of the client node to the receiving device and the receiving device compares the GPS coordinates of the client node to those coordinates that reside in a database of sanctioned locations on the receiving device. If there GPS coordinates from the client node match a set of GPS coordinates in the database of sanctioned locations the client node is allowed to log into the system and the receiving device allows access to the system if the GPS coordinates and other log in credentials are correct. The log in credentials can include a username and password as well as a pin. Some systems may provide additional security by issuing a single use pin to the user through the use of SMS text messaging or email.

An alternative security system can consist of a database of sanctioned IP addresses of permitted client nodes on the receiving system. This database is used to confirm that the client node trying to access the system is actually a sanctioned device. The security system works as follows the client node sends the IP address to the receiving device and the receiving device checks the IP address is in a database of sanctioned IP addresses on the receiving device sanctioned IP address database. If the IP address of the client node is in the database of sanctioned IP addresses on the receiving device then then the client node is allowed to log into the receiving device if the IP address is correct and other log in credentials are correct. The log in credentials can include a username and password as well as a pin. Some systems may provide additional security by issuing a single use pin to the user through the use of SMS text messaging or email.

In one embodiment, the system integrates the AI-powered custom GPT-a trained assistant feature that could be added to the patent application. It covers key methodology subjects like responsibilities, performance measures, and organizational improvement opportunities, among other relevant topics. Here's a detailed breakdown on how to include these elements effectively:

### Enhanced User Assistance and Decision-Making Support

Responsibilities and Performance Measures: The AI-powered assistant provides users with immediate access to expert advice on defining and assigning organizational responsibilities. It offers best practices and customized suggestions based on the organization's needs, ensuring roles are clearly defined and aligned with strategic objectives.

The system software includes an integrated AI-powered Custom GPT trained assistant that aids users in defining responsibilities and performance measures. This assistant leverages advanced natural language processing to provide tailored advice and best practices, ensuring that organizational roles are clearly defined and aligned with strategic objectives, making it easy for the user to start and develop their talent management framework with both ease and depth.

Organizational Improvement Opportunities: The Custom GPT trained AI assistant analyzes performance data and identifies areas for improvement. It provides actionable recommendations to resolve issues, streamline processes, and enhance overall performance, ensuring continuous organizational improvement and strategic alignment.

The system includes the use of an AI Custom GPT assistant capable of analyzing real-time performance data to identify and suggest resolutions for organizational improvement opportunities. By offering actionable insights and tailored recommendations, the AI ensures that organizations can swiftly address performance gaps and optimize their operations.

User Engagement and Training: The AI Custom GPT trained assistant engages users by answering questions, providing guidance, and offering real-time support. This enhances user experience, promotes continuous learning, and ensures informed decision-making based on the latest data and best practices.

The AI-powered Custom GPT trained assistant engages users through an interactive interface, providing real-time support and guidance. This feature ensures that users are continuously learning and making informed decisions, leading to improved engagement and better performance outcomes.

4. Training and Onboarding: The Custom GPT assistant facilitates training and onboarding by offering personalized learning modules, answering common questions, and providing resources that help new users quickly understand and utilize the software effectively.

The integrated Custom GPT AI assistant also functions as a training and onboarding tool, offering personalized learning modules and resources. This feature ensures that new users can quickly become proficient with the software, thereby reducing onboarding time and enhancing overall user satisfaction.

Strategic Planning and Execution: The assistant helps align day-to-day operations with strategic goals by providing insights and recommendations that ensure all activities contribute to the organization's long-term objectives.

The Custom GPT trained AI assistant plays a crucial role in strategic alignment by offering insights and recommendations that ensure daily operations are in sync with the organization's long-term goals. This feature supports the seamless integration of strategic planning and execution.

Scenario Planning and Risk Management: The Custom GPT AI assists with scenario planning and risk management by generating potential scenarios, evaluating risks, and suggesting mitigation strategies. This proactive approach helps organizations prepare for and navigate uncertainties.

One component of the system is the Custom GPT trained AI assistant's capability to support scenario planning and risk management. By generating potential scenarios and evaluating associated risks, the AI provides organizations with strategic foresight and mitigation strategies, enhancing their preparedness and resilience.”

Integration into Patent Application Sections: The AI assistant aids in defining responsibilities, establishing performance measures, and identifying improvement opportunities.

The AI assistant's recommendations lead to significant improvements in organizational performance.

The system demonstrates the innovative use of advanced Custom GPT AI technology to power the methodology's user to enhance organizational performance. By detailing its practical applications and benefits, the patent application will be strengthened, highlighting the value and uniqueness of the invention. This approach will solidify the patent application, making a compelling case for its approval.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A system for applying performance management in a business method, the system comprising:
a supervisory computer having at least one known location associated with an ISP and or Email and or GPS location and a supervisory computer database that stores at least one known location data at least one manager data and at least one employee data wherein the supervisory computer includes a supervisory algorithm for allowing at least one manager to document an organization mission, an organization vision, strategic objectives of an organization, expected behavior within the organization, and systemic performance indicators;
at least one management computer in communication with the supervisory computer, the at least one management computer having a management application, a management ISP and or management Email and or management GPS module wherein the at least one management computer includes a manager algorithm for allowing the at least one manager to convey the organization mission, the organization vision, the organization strategic objectives, the organization expected behaviors, and the organization systemic performance indicators to an at least one employee;
at least one employee computer in communication with the supervisory computer, the at least one employee computer having an employee application, an employee ISP and or employee Email and or employee GPS module wherein the at least one employee computer includes an employee algorithm for guiding the at least one employee to assemble systemic performance indicators data; provide a review of the systemic performance indicators; analyze the Systemic Performance Indicators; and document the review of the Systemic Performance Indicators; identify and document suggested corrective actions for Systemic Performance Indicators that are not in compliance with agreed to Systemic Performance Indicators;
wherein the at least one management computer sends the management ISP and or management Email and or management GPS location of the at least one management computer to the supervisory computer and the supervisory computer, ISP and or Email and or GPS location of the at least one management computer to determine at least one known location and the supervisory computer database stores the at least one known location data with the at least one manager data manager data;
wherein the at least one management computer allows the at least one manager to document the organization's Systemic Performance Indicators;
wherein the at least one management computer allows the manager algorithm to transfer the organizations mission, the organizations vision, the organizations strategic objectives, the organizations expected behaviors, the organizations Systemic Performance Indicators to the supervisory computer system;
wherein the supervisor computer system transfers the organizations mission, the organizations vision, the organizations Strategic Objectives, the organizations expected behaviors, the organizations Systemic Performance Indicators to at least one employee computer;
wherein the at least at least one employee computer sends the ISP and or Email and or GPS location of the at least at least one employee computer to the supervisory computer system and the supervisory system compares the ISP and or Email and or GPS location of the at least at least one employee computer and determines a known location stored in the supervisor computer system database stores the at least one known location data with the at least one employee data and downloads specific known location information stored in the supervisor computer system in the at least on employee data;
wherein the at least one employee computer allows the at least one employee to assemble data which correlates to the Systemic Performance Indicators and using the at least one employee computer with the employee application transfers the data which correlates to the Systemic Performance Indicators to the supervisor computer system and the supervisory computer system stores the data which correlates to the Systemic Performance Indicators to the supervisory computer database;
wherein the at least one employee computer allows the at least one employee to input data for the Systemic Performance Indicators and documents employee input data and the at least one employee computer system stores the employee input data to the Systemic Performance Indicators to the supervisory computer database;
wherein the at least one employee computer allows the at least one employee to review the Systemic Performance Indicators on the supervisory computer database using the at least one employee computer system and analyzes the Systemic Performance Indicators and documents the review of the Systemic Performance Indicators using the at least one employee computer system and stores the Systemic Performance Indicators to the supervisory computer database;
wherein the at least one employee computer allows the at least one employee to identify and document suggested corrective actions for the Systemic Performance Indicators that are not in compliance with the agreed to the Systemic Performance Indicators;
wherein the at least one management computer allow the at least one manager and the at least one employee to use the manager for meeting to review the Systemic Performance Indicators stored in the supervisory computer database;
wherein the system allows the at least one manager and the at least one employee to agree upon and document the Systemic Performance Indicators results and corrective actions for the Systemic Performance Indicators at the meeting and using the at least one management computer system with the management application store Systemic Performance Indicators in the supervisory computer database;
wherein the system allows the at least one manager and the at least one employee to meet at a next meeting and review the Systemic Performance Indicators results and corrective actions for the Systemic Performance Indicators stored in the supervisory computer database using the management computer;
wherein the system allows the at least one manager and the at least one employee to agree upon and document the Systemic Performance Indicators results and agreed upon corrective actions for the Systemic Performance Indicators stored in the supervisory computer database using the management computer at the next meeting;
wherein the supervisory computer uses Artificial Intelligence and Aided Pattern Recognition and to analyze and or experiment with positive and negative pattern correlations between methods and practices with both positive and negative results to create knowledge and data trends;
wherein the system allows the at least one manager and the at least one employee to, at the next meeting, to agree upon corrective actions from prior review sessions not executed will result in disciplinary actions;
wherein the supervisory computer uses Business Intelligence to provide relevant and result hard data-based facts for producing an Organizational Development Plan;
wherein the supervisory computer uses Business Intelligence provides relevant and result hard data-based facts for producing Process Development Plans; and
wherein the supervisory computer uses Business Intelligence provides relevant and result hard data-based facts for producing Individual Development Plans.

2. The system of claim 1 wherein the employee input comprises task performance, quality of output, on time results, new client recruitment, response times and service times.

3. The system of claim 2 wherein the corrective actions are specific to Systemic Performance Indicators.

4. The system of claim 1 wherein the system integrates a specifically prepared and painless methodology that balances clear definition of responsibilities with a focus on achieving process improvement-based results, ensuring that the employee is aware of their specific tasks and are continuously driven to improve their processes and outcomes.

5. The system of claim 2 wherein the system incorporates a participative performance evaluation process, allowing employees to assess their own performance, fostering greater involvement and motivation, making the system particularly effective for managing off-site and hybrid workers.

6. The system of claim 3 wherein the system implements continuous process improvement for ensuring that employees and the organization consistently work towards higher performance standards and better results.

7. The system of claim 1 wherein including a custom GPT trained AI assistant for providing tailored advice, analyze performance data, and offer real-time support for strategic planning and execution.
